(19) United States
(12) Patent Application Publication
(10) Pub. No.: US 2022/0300067 A1
(43) Pub. Date: Sep. 22, 2022

(54) VIRTUAL EXPERIENCE DEVICE, VIRTUAL EXPERIENCE METHOD, AND STORAGE MEDIUM

(71) Applicant: HONDA MOTOR CO., LTD., Tokyo (JP)

(72) Inventors: Noriyuki Ishida, Wako-shi (JP); Sachiko Yamamoto, Wako-shi (JP); Satoshi Haneda, Tokyo (JP); Daiki Kawashima, Tokyo (JP); Shinichiro Kobashi, Wako-shi (JP); Shota Yamaguchi, Wako-shi (JP); Marika Mochizuki, Wako-shi (JP)

(21) Appl. No.: 17/681,865

(22) Filed: Feb. 28, 2022

(30) Foreign Application Priority Data
Mar. 19, 2021 (JP) 2021-045503 F

(51) Int. Cl. G06F 3/01; G06Q 30/02; G06T 19/00

(52) U.S. Cl. CPC G06F 3/011; G06Q 30/0271; G06Q 30/0273; G06Q 30/0207; G06T 19/003; G06T 19/006

(57) ABSTRACT

A virtual experience device provides a user with a service that allows the user to have a virtual experience in a virtual reality video based on a virtual world that virtually reproduces a real world or a fictional world, determines an advertisement video to be included in the virtual reality video on the basis of attributes of the user who receives the service, generates the virtual reality video including the advertisement video in a predetermined advertisement display region, and displays the virtual reality video on a display device.

### CROSS-REFERENCE TO RELATED APPLICATION

This application is based upon and claims the benefit of priority from Japanese Patent Application No. 2021-045503, filed Mar. 19, 2021, the entire contents of which is incorporated herein by reference.

### BACKGROUND

### Field of the Invention

The present invention relates to a virtual experience device, a virtual experience method, and a storage medium.

### Description of Related Art

In the related art, there is an experience device that allows a virtual travel experience to be shared with a user who is considering details of a travel including a travel destination, a travel plan, or the like by showing a virtual reality video (refer to, for example, Japanese Unexamined Patent Application, First Publication No. 2018-155887). There is a technique for displaying an advertisement according to a user's attribute to the user who plays a game or the like while watching a video (refer to, for example, Japanese Unexamined Patent Application, First Publication No. 2017-182505).

### SUMMARY

However, neither of the above techniques of the related art displays an advertisement on a virtual reality video for a user who experiences virtual travel. Thus, for example, even when an advertisement is displayed on a virtual reality video, it is difficult to increase the appeal to a user for such an advertisement target.

The present invention has been made in consideration of such circumstances, and one object thereof is to provide a virtual experience device, a virtual experience method, and a storage medium capable of increasing the appeal to a user who has a virtual experience by watching a virtual reality video for an advertisement target.

The virtual experience device, the virtual experience method, and the storage medium according to the present invention employ the following configurations.

(1) According to a first aspect of the present invention, a virtual experience device is provided including a storage medium that stores computer-readable instructions; and a processor connected to the storage medium, in which the processor executes the computer-readable instructions to provide a user with a service that allows the user to have a virtual experience in a virtual reality video based on a virtual world that virtually reproduces a real world or a fictional world, determine an advertisement video to be included in the virtual reality video on the basis of attributes of the user who receives the service, generate the virtual reality video including the advertisement video in a predetermined advertisement display region, and display the virtual reality video on a display device.

(2) According to a second aspect of the present invention, in the first aspect, the processor sets an advertisement charge for displaying the advertisement video, adjusts the advertisement charge on the basis of the user's stop frequency in the virtual reality video, and sets the advertisement charge to become higher as the stop frequency becomes higher.

(3) According to a third aspect of the present invention, in the second aspect, the virtual reality video is a video that virtually reproduces the real world, and the processor excludes a region of the virtual reality video that overlaps a landscape-oriented point in the real world from a region where the advertisement video is displayed.

(4) According to a fourth aspect of the present invention, in any one of the first to third aspects, the processor determines the advertisement video further on the basis of an advertisement display place which is a place where the advertisement video is displayed.

(5) According to a fifth aspect of the present invention, in the fourth aspect, in a case where incidental information possessed by a target object is included in the virtual reality video, the processor displays the incidental information in preference to the advertisement video on the display device.

(6) According to a sixth aspect of the present invention, in any one of the first to fifth aspects, the advertisement video is an advertisement video for assigning a first coupon that can be used in the virtual world to the user, and the processor assigns the first coupon to the user in a case where the user executes a first action while the user is receiving the service or after the user has received the service.

(7) According to a seventh aspect of the present invention, in any one of the first to fifth aspects, the advertisement video is an advertisement video that assigns a second coupon that can be used in the real world to the user, and the processor assigns the second coupon to the user in a case where the user executes a second action while the user is receiving the service or after the user has received the service.

(8) According to an eighth aspect of the present invention, a virtual experience method is provided for causing a computer to provide a user with a service that allows the user to have a virtual experience in a virtual reality video based on a virtual world that virtually reproduces a real world or a fictional world; determine an advertisement video to be included in the virtual reality video on the basis of attributes of the user who receives the service; generate the virtual reality video including the advertisement video in a predetermined advertisement display region; and display the virtual reality video on a display device.

(9) According to a ninth aspect of the present invention, a non-transitory storage medium is provided storing computer-readable instructions for causing a computer to execute providing a user with a service that allows the user to have a virtual experience in a virtual reality video based on a virtual world that virtually reproduces a real world or a fictional world; determining an advertisement video to be included in the virtual reality video on the basis of attributes of the user who receives the service; generating the virtual reality video including the advertisement video in a predetermined advertisement display region; and displaying the virtual reality video on a display device.

According to the above aspect, it is possible to increase the appeal to a user who has a virtual experience by watching a virtual reality video for an advertisement target.

### BRIEF DESCRIPTION OF THE DRAWINGS

FIG. 1 is a diagram showing an example of a configuration of a virtual experience system of a first embodiment.

FIG. 2 is a perspective view showing a second moving object.

FIG. 3 is a diagram showing an example of details of a user list.

FIG. 4 is a diagram showing an example of details of an advertisement list.

FIG. 5 is a bird's-eye view of a user who uses a virtual experience facility.

FIG. 6 is a diagram showing an example of a first virtual reality video displayed on a display device.

FIG. 7 is a diagram showing an example of a local video that is a source for generating the first virtual reality video.

FIG. 8 is a flowchart showing an example of a process of a virtual experience device.

FIG. 9 is a diagram showing an example of a configuration of a virtual experience device of a second embodiment.

FIG. 10 is a diagram showing an example of details of an advertisement list in the second embodiment.

FIG. 11 is a diagram showing an example of details of a landscape-oriented point list.

FIG. 12 is a diagram showing an example of details of an incidental information list.

FIG. 13 is a diagram showing an example of details of a stop frequency list.

FIG. 14 is a diagram showing an example of details of an advertisement charge table.

FIG. 15 is a diagram showing an example of details of a coupon list.

FIG. 16 is a flowchart showing an example of a process of the virtual experience device of the second embodiment before a user experiences a virtual travel.

FIG. 17 is a flowchart showing an example of a process of the virtual experience device of the second embodiment when the user is experiencing the virtual travel.

### DESCRIPTION OF EMBODIMENTS

Hereinafter, embodiments of a virtual experience device, a virtual experience method, and a storage medium of the present invention will be described with reference to the drawings. A virtual experience system provided with the virtual experience device is, for example, a system that provides a virtual experience such as a virtual travel experience by using a virtual experience facility using the virtual experience device. The virtual experience device provides a service for providing a virtual experience of a virtual world representing a real world or a fictional world to a user. In the virtual experience system, it is possible to have a virtual experience other than a virtual travel experience, for example, a virtual experience such as an unrealistic game world.

### First Embodiment

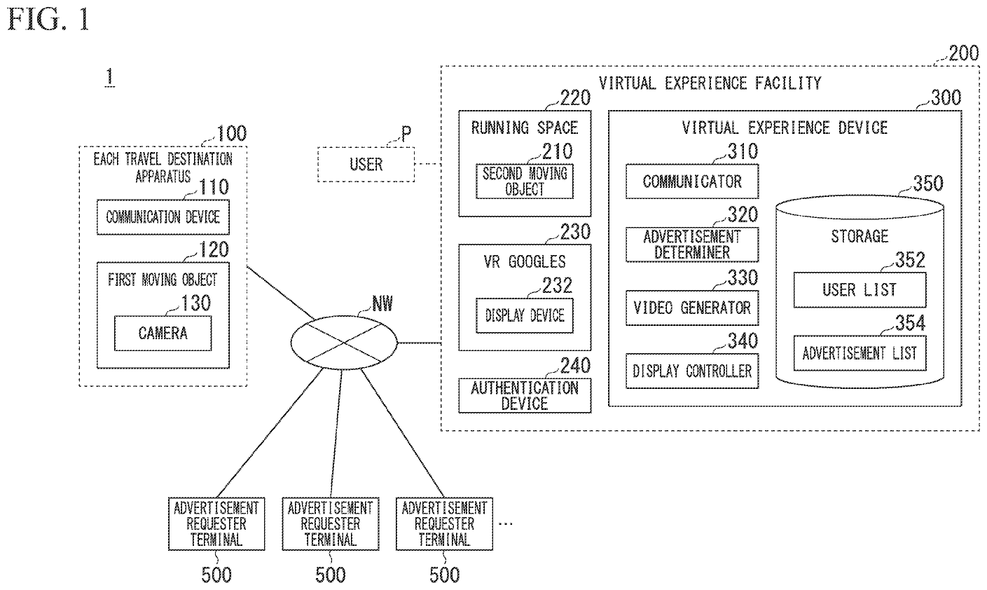

FIG. 1 is a diagram showing an example of a configuration of a virtual experience system 1 of a first embodiment. The virtual experience system 1 includes, for example, each travel destination apparatus 100 provided at a travel destination, a virtual experience facility 200, and a virtual experience device 300. The virtual experience system 1 is used by, for example, a user P who virtually travels in a certain travel destination. The virtual experience system 1 can communicate with a plurality of advertisement requester terminals 500 via a network NW.

Each travel destination apparatus 100 includes a communication device 110, a first moving object 120, and a camera 130. The virtual experience facility 200 includes, for example, a second moving object 210, a running space 220 in which the second moving object 210 runs, a head mounted display, for example, virtual reality (VR) goggles 230 worn by the user P, an authentication device 240, and the virtual experience device 300.

In the virtual experience facility 200, the user P riding on the second moving object 210 wears the VR goggles 230 and runs in the running space 220 to experience a virtual travel. At a travel destination (local) that is a target of the virtual travel experience, the first moving object 120 moves in accordance with movement of the second moving object 210. The camera 130 is mounted on the first moving object 120, and the camera 130 captures a video of the surroundings of the first moving object 120. In the virtual experience facility 200, the user P has a virtual travel experience of traveling in a travel destination while watching a virtual reality video. The user P receives the service provided by the virtual experience device 300. The user P is an example of a user.

The virtual reality video watched by the user P who experiences the virtual travel is generated on the basis of a video of real scenery (hereinafter, a local video) captured by the camera 130 at the travel destination. The virtual reality video may include a large signboard, for example, in a case where the first moving object 120 moves on a road. In the virtual reality video, an advertisement video according to an attribute of the user P is included and displayed by being applied to the large signboard.

The virtual reality video of the first embodiment is a video of a virtual world based on the real world. The virtual reality video may be a video of a virtual world based on a fictional world. A video representing the fictional world may be, for example, a fictitious video generated by computer graphics or the like, or a video in which a fictitious video and a real video are mixed.

An advertisement that is a target of an advertisement video included in the virtual reality video is, for example, an advertisement generated on the basis of advertisement request information transmitted by the advertisement requester terminal 500. In a case where an advertisement video is displayed in the virtual reality video, an advertisement requester who manages the advertisement requester terminal 500 pays an advertisement charge according to a request from an administrator of the virtual experience device 300.

The communication device 110 is a wireless communication module for connection to, for example, a network or directly communicating with another terminal device, for example, the virtual experience device 300 of the virtual experience facility 200. The communication device 110 performs wireless communication on the basis of Wi-Fi, Dedicated Short Range Communications (DSRC), Bluetooth (registered trademark), and other communication standards. The communication device 110 can communicate with the virtual experience facility 200 via the network NW.

The first moving object 120 is, for example, a small moving object capable of running in a city. The first moving object 120 moves in the same manner as the first moving object 120 on the basis of running control information transmitted by the communication device 110. When the first moving object 120 becomes immovable or has difficulty in moving in the city, automatic running control is performed such that the first moving object 120 can move while avoiding the current situation.

The camera 130 is mounted on the first moving object 120. The camera 130 captures a local video of the travel destination. The camera 130 outputs the captured local video to the communication device 110. The communication device 110 transmits the output local video to the virtual experience facility 200. In the first embodiment, the camera 130 is mounted on the first moving object 120, but may be provided by means other than mounting on the first moving object 120. For example, the camera 130 may be mounted on a drone flying in the vicinity of the first moving object 120.

In a case of using the virtual experience facility 200, the user P is authenticated by the authentication device 240 when entering the virtual experience facility 200. Subsequently, the user P wears the VR goggles 230, gets on the second moving object 210, and moves in the running space 220. The VR goggles 230 are provided with a display device 232 for displaying a video that can be visually recognized by the user P.

A control device of the second moving object 210 transmits riding information to the virtual experience device 300 when the user P is riding on the second moving object 210. The control device transmits movement information corresponding to movement of the second moving object 210 to the virtual experience device 300. For example, the control device transmits movement start information to the virtual experience device 300 when the second moving object 210 starts moving. When the moving second moving object 210 stops, the control device transmits stop information to the virtual experience device 300.

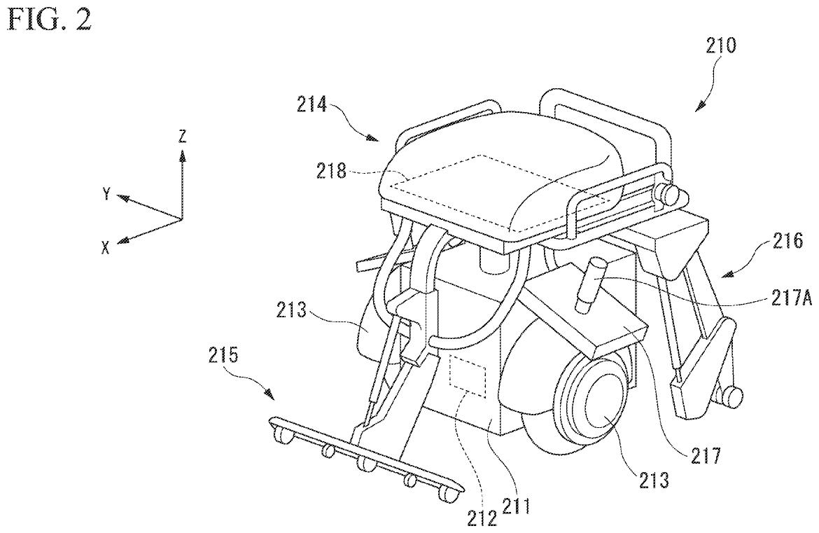

FIG. 2 is a perspective view showing the second moving object 210. Hereinafter, a front-rear direction of the second moving object 210 may be referred to as an X direction, a lateral direction may be referred to as a Y direction, and a direction orthogonal to the X direction and the Y direction may be referred to as a Z direction. The second moving object 210 is a moving object on which the user P can ride in the virtual experience facility 200. The second moving object 210 runs in the running space 220 according to an operation of the user P.

The second moving object 210 includes, for example, a base 211. A control device 212 is housed inside the base 211. The control device 212 controls a running direction, a running speed, and the like of the second moving object 210. In addition to the control device 212, a motor, a battery, and the like are housed inside the base 211. Wheels 213 are respectively assembled on the left and right sides of the base 211.

A seating portion 214 is provided on an upper part of the base 211. The seating portion 214 forms a cushion on which the user sits. An upper surface of the seating portion 214 is a seating surface that supports the user's buttocks from below. The seating portion 214 is supported by the base 211. The seating portion 214 is supported by the base 211, a first support portion 215 disposed in front of the base 211, and a second support portion 216 disposed behind the base 211. The first support portion 215 and the second support portion 216 support the seating portion 214 such that the seating portion is movable up and down.

An operation portion 217 is provided on the side of the seating portion 214. The operation portion 217 includes an operator 217A for an operator to control an operation of the second moving object 210. For example, the operator 217A is an operator for controlling a running direction, a running speed, a braking operation, and the like of the second moving object 210. The operation portion 217 transmits an operation signal corresponding to an operation of the operator 217A to the control device 212. An occupant such as the user P can cause the second moving object 210 to run by operating the operator 217A.

A load sensor 218 is provided inside the seating portion 214. The load sensor 218 detects a position where an occupant puts his/her weight on the seating portion 214. For example, when the occupant leans forward, a load of the occupant is detected in front of the seating portion 214. The load sensor 218 transmits a load signal corresponding to the detected load to the control device 212. The control device 212 causes the second moving object 210 to run with reference to the direction in which the load sensor 218 detects the load of the occupant. As described above, the occupant can cause the second moving object 210 to run (move) by operating the operator 217A or by applying a load in a direction in which he/she wants to move. The control device 212 controls the running of the second moving object 210 on the basis of the operation signal transmitted by the operation portion 217 and the load signal transmitted by the load sensor 218.

The second moving object 210 of the embodiment is a so-called hands-free second moving object 210 that can be operated by the weight movement of an occupant, and can be operated by the operation of the operation portion 217 by the occupant, but the operation portion 217 needs not be provided. The second moving object 210 may be a saddle-mounted moving object that the occupant straddles. The second moving object 210 may be a moving object such that a worker gets on a step while standing upright. The second moving object 210 may move by walking with legs instead of the wheels.

The running space 220 is a space having a size that allows the second moving object 210 to move, for example, a space having a bottom area of about several meters × several meters. The running space 220 is provided at an appropriate place such as in a building.

The VR goggles 230 display a video that is based on the local video transmitted by the communication device 110 and reminds the user P of a virtual space. The VR goggles 230 include a display device 232 that displays a virtual reality video, and a mounting portion that is hooked on the head of the user P to attach the VR goggles 230 to the user P such that the user P can see the display device 232. Instead of the VR goggles 230, mixed reality (MR) goggles or augmented reality (AR) goggles may be used.

The authentication device 240 is provided, for example, at an entrance of the virtual experience facility 200. The authentication device 240 authenticates the user P with, for example, an authentication card brought by the user P. In a case where the user P is authenticated, the authentication device 240 transmits authentication information to the virtual experience device 300. The authentication information includes an ID number of the user P.

The virtual experience device 300 causes the VR goggles 230 to display a video corresponding to the running of the second moving object 210. The user P who wears the VR goggles 230 has a virtual travel experience of a travel destination where the first moving object 120 moves on the basis of a video displayed on the VR goggles 230 and movement of the second moving object 210.

The virtual experience device 300 includes, for example, a communicator 310, an advertisement determiner 320, a video generator 330, a display controller 340, and a storage 350. The advertisement determiner 320, the video generator 330, and the display controller 340 are realized by, for example, a processor such as a central processing unit (CPU) that is hardware executing a program (software). One or both of the video generator 330 and the display controller 340 may be realized by hardware (a circuit portion; including circuitry) such as a large scale integration (LSI), an application specific integrated circuit (ASIC), a field-programmable gate array (FPGA), or a graphics processing unit (GPU), and may be realized by software and hardware in cooperation. The program may be stored in advance in a storage device (a storage device provided with a non-transitory storage medium) such as an HDD or a flash memory, and may be stored in an attachable and detachable storage medium (non-transitory storage medium) such as a DVD or a CD-ROM and may be installed in the HDD or the flash memory when the storage medium is attached to a drive device. The storage device is realized by a hard disk drive (HDD), a DVD, a random access memory (RAM), a flash memory, or the like. The storage 350 is realized by the above storage device. The storage 350 stores a user list 352 including attributes of the user P or the like who uses the virtual experience facility 200, and an advertisement list 354 according to attributes of users.

The communicator 310 is a wireless communication module for connection to, for example, a network or directly communicating with another terminal device, for example, a communication device 110 of each travel destination apparatus 100, or the advertisement requester terminal 500. The communicator 310 performs wireless communication on the basis of Wi-Fi, DSRC, Bluetooth (registered trademark), and other communication standards.

The communicator 310 receives a local video transmitted by the communication device 110. The communicator 310 outputs the received local video to the video generator 330. The communicator 310 receives movement information transmitted by the control device 212. The communicator 310 outputs the received movement information to the video generator 330. The communicator 310 receives authentication information transmitted by the authentication device 240. The communicator 310 outputs the received authentication information to the advertisement determiner 320.

The advertisement determiner 320 uses an ID number included in the authentication information transmitted by the communicator 310 to specify attributes of the user P by referring to the user list 352. The advertisement determiner 320 is an example of a determiner. The attributes include, for example, items such as a gender, an age, a place of residence, an occupation, and a hobby. Here, the user list 352 and the advertisement list 354 will be described.

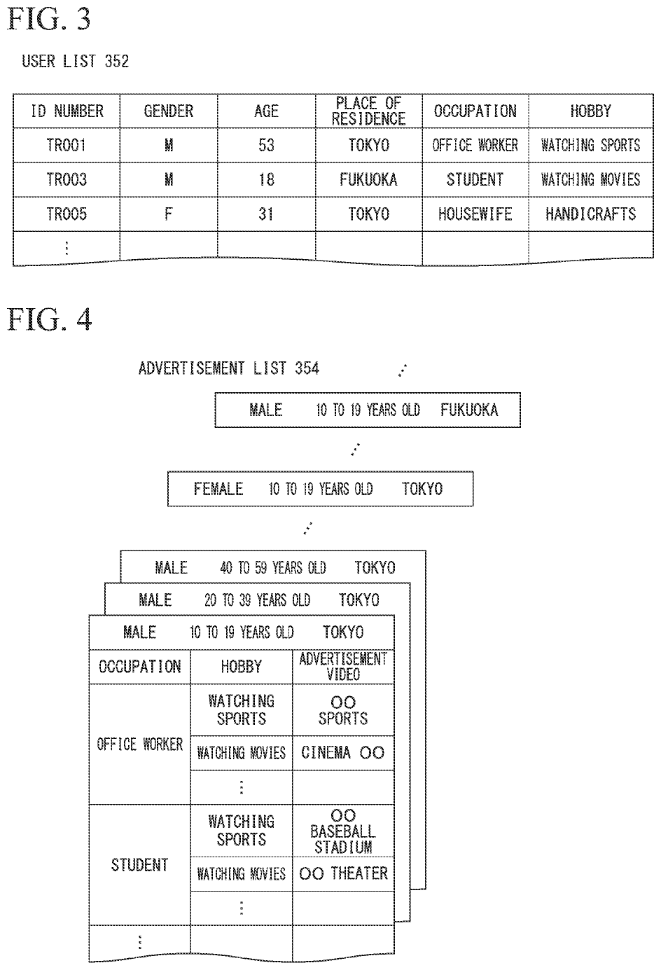

FIG. 3 is a diagram showing an example of details of the user list 352. The user list 352 shows attributes of users corresponding to the users' ID numbers. For example, among attributes of the user whose ID number is TR001, the gender attribute is male, the age attribute is 53 years old, the place of residence attribute is Tokyo, the occupation attribute is office worker, and the hobby attribute is “watching sports.”

FIG. 4 is a diagram showing an example of details of the advertisement list 354. The advertisement list 354 includes a plurality of lists divided by a gender, an age, and a residential area. Each list has details of an advertisement according to an occupation and a hobby. For example, in a case where the user's gender is male, the age group is 10 to 19 years old, the place of residence is Tokyo, the occupation is an office worker, and the hobby is “watching sports,” the advertisement video determined is a video of OO Sports. The provided advertisement video may be a moving video or a still video.

The advertisement video included in the advertisement list 354 is an advertisement video generated on the basis of advertisement request information transmitted by the advertisement requester terminal 500. The advertisement video is, for example, an advertisement that advertises an advertisement requester. The advertisement determiner 320 uses the specified attributes of the user P to determine an advertisement video to be included in the virtual reality video by referring to the advertisement list 354. The advertisement determiner 320 notifies the video generator 330 of the determined advertisement video to be included in the virtual reality video.

The advertisement determiner 320 further performs image processing on the local video to retrieve a region to be an advertisement display region in the local video, for example, a large signboard on which a poster or the like is attached. In a case where the advertisement determiner 320 finds a large signboard in the local video, the advertisement determiner 320 notifies the video generator 330 of the retrieval information. The advertisement display region may be a region other than a large signboard as long as it has a certain area. The advertisement display region may be, for example, a medium-sized or small-sized signboard, a billboard, a monitor, or the like, which is recognized within a range of attracting attention of the user P who has a virtual travel experience.

The video generator 330 generates a virtual reality video to be displayed on the display device 232 of the VR goggles 230 in a case where the movement start information is output by the communicator 310. The video generator 330 generates the virtual reality video on the basis of the local video output by the communicator 310, the movement information output by the control device 212, and the advertisement video information reported by the advertisement determiner 320.

The video generator 330 generates the virtual reality video on the basis of the local video output by the communicator 310, for example, at a timing at which the movement start information is transmitted by the control device of the second moving object 210. The video generator 330 calculates a position of the user P in the virtual reality video on the basis of the movement information transmitted by the control device of the second moving object 210. For example, the video generator 330 generates the virtual reality video to be viewed when the user P advances in the virtual reality video in a case where a movement signal indicating that the second moving object 210 advances is transmitted. By causing the second moving object 210 to move while watching the virtual reality video, the user P can have a virtual experience of traveling in the scenery reflected in the virtual reality video.

In a case where the retrieval information is reported by the advertisement determiner 320, the video generator 330 generates the virtual reality video in which the advertisement video based on the advertisement video information reported by the advertisement determiner 320 is applied to a large signboard. The video generator 330 notifies the display controller 340 of information regarding the generated virtual reality video.

The display controller 340 displays the virtual reality video based on the information regarding the virtual reality video reported by the video generator 330 on the display device 232. The user P visually recognizes the virtual reality video displayed on the display device 232.

Next, a procedure of using the virtual experience facility 200 will be described. In the virtual experience facility 200, the user P wears the VR goggles 230 before entering the running space 220. A virtual door is displayed on the VR goggles 230, and the user P has a virtual travel experience of moving to a favorite destination through the virtual door.

Subsequently, a virtual tunnel is displayed on the VR goggles 230. User P passes through the virtual tunnel and has a virtual experience of becoming smaller. The user P moves to the running space 220 through the virtual experience of passing through the virtual tunnel, and gets on the second moving object 210. The user P rides on the second moving object 210 in the running space 220 and causes the second moving object 210 to run while watching the video displayed on the VR goggles 230, and thus the user P experiences a virtual travel of traveling to a destination as a dwarf.

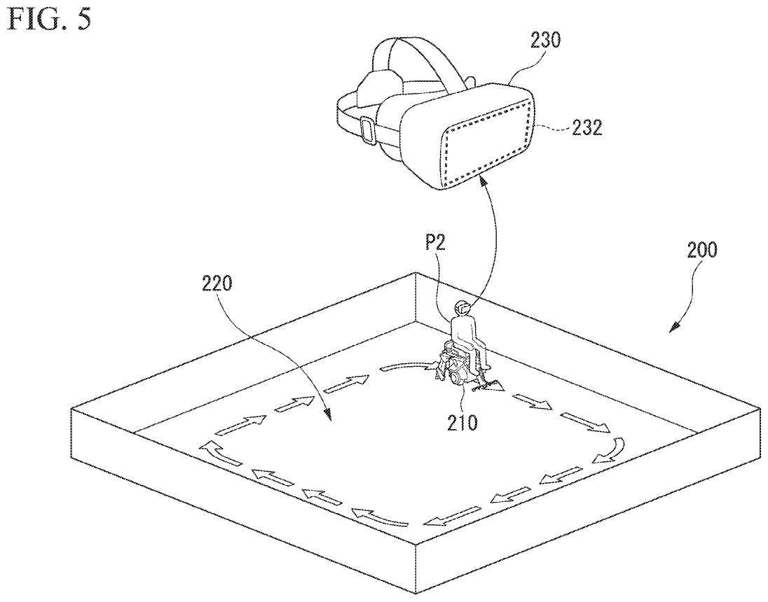

FIG. 5 is a bird's-eye view of the user P who uses the virtual experience facility 200. The user P operates the operator of the second moving object 210 while wearing the VR goggles 230 in the running space 220, or tilts his/her body on the seating portion in a direction in which the user desires to move, so that the moving object 210 moves. At the virtual experience facility 200, a virtual travel can be experienced according to the movement of the second moving object 210.

For example, when the user P applies a load forward on the seating portion, the second moving object 210 goes straight. In this case, a video in which the user P is heading forward is displayed on the VR goggles 230. The video shows the scenery of the destination of the virtual travel and part of the user P. The second moving object 210 runs in the running space 220 due to an action of the user P, but, for example, in a case where the second moving object 210 is about to collide with a wall portion in the running space 220, a trajectory of the second moving object 210 is corrected by guiding the second moving object 210 such that the correction is not noticed by the user P.

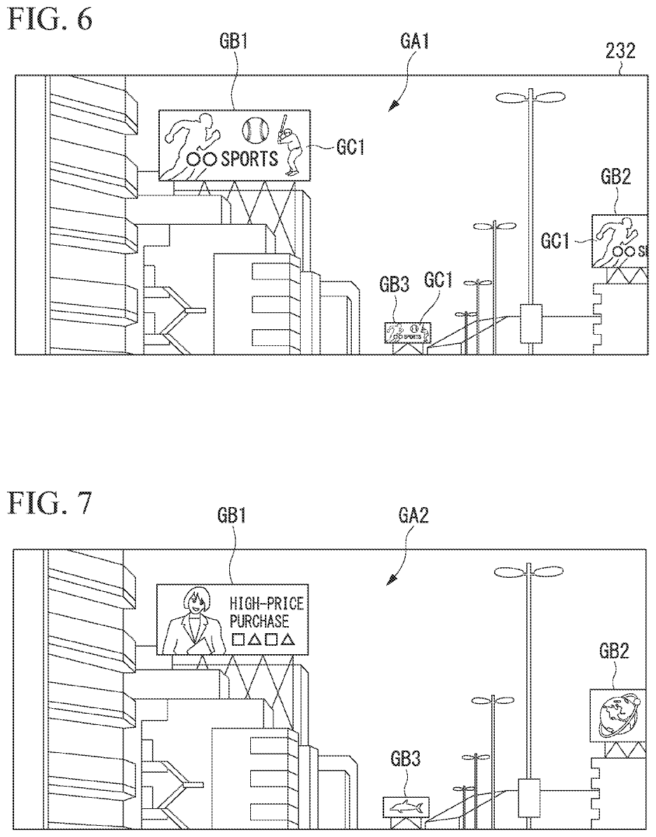

FIG. 6 is a diagram showing an example of a first virtual reality video GA1 displayed on the display device 232. The user P riding on the second moving object 210 experiences a virtual travel while watching the video displayed on the display device 232. The first virtual reality video GA1 displayed on the display device 232 is a video generated on the basis of a video of the scenery of the travel destination captured by the camera 130.

FIG. 7 is a diagram showing an example of a local video GA2 that is a source for generating the first virtual reality video GA1. Details of the first virtual reality video GA1 are changed depending on whether or not a large signboard is included. The local video GA2 includes a first large signboard video GB1 to a third large signboard video GB3 as videos of large signboards. In the first virtual reality video GA1 in this case, an advertisement video GC1 generated by the video generator 330 is applied to a region where a poster is attached to each of the first large signboard video GB1 to the third large signboard video GB3. The advertisement video GC1 is applied to each of the first large signboard video GB1 to the third large signboard video GB3, and thus the first virtual reality video GA1 shown in FIG. 6 is generated. The first large signboard video GB1 to the third large signboard video GB3 may be common or different.

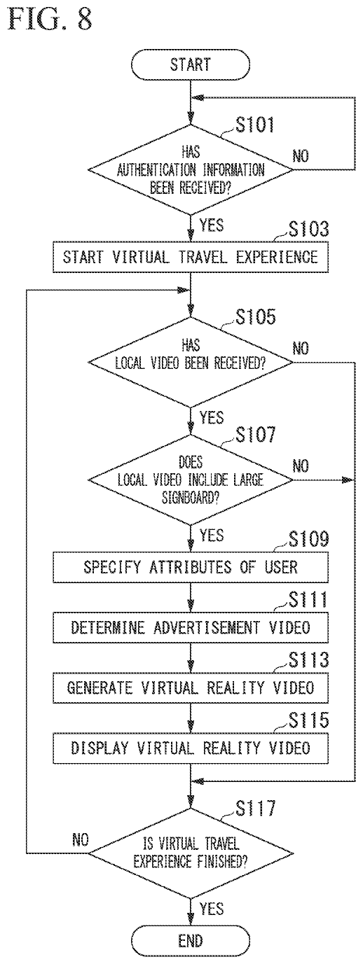

Next, a process of the virtual experience device 300 will be described. FIG. 8 is a flowchart showing an example of a process of the virtual experience device 300. First, the virtual experience device 300 determines whether or not the advertisement determiner 320 has received authentication information transmitted by the authentication device 240 (step S101).

In a case where it is determined that the authentication information has not been received, the virtual experience device 300 repeatedly performs the process in step S101 until the authentication information is received. In a case where it is determined that the authentication information has been received, the advertisement determiner 320 checks an ID number of the user P who uses the virtual experience facility 200 on the basis of the authentication information and starts a virtual travel experience in the virtual experience facility 200 (step S103).

Subsequently, the video generator 330 determines whether or not a local video transmitted by the communication device 110 of each travel destination apparatus 100 and received by the communicator 310 has been received (step S105). In a case where it is determined that the local video has not been received, the video generator 330 causes the process to proceed to step S117. The video generator 330 may generate a virtual reality video in a separate process in a case where a certain period of time has elapsed without receiving the local video.

In a case where it is determined that the local video has been received, the video generator 330 determines whether or not the local video is a video including a large signboard (step S107). In a case where it is determined that the local video is not a video including a large signboard, the video generator 330 causes the process to proceed to step S117. In a case where a time for which the local video is determined as not including a large signboard has elapsed by a certain period of time, an advertisement display region for including an advertisement video may be set in the local video in a separate process. The advertisement display region may be, for example, a region in which there is little change in pixel information, that is, a region in which there is little change when advertisement is displayed and which has a large area.

In a case where the video generator 330 determines that the local video is a video including a large signboard, the advertisement determiner 320 uses the ID number obtained by checking the authentication information received by the communicator 310 to specify attributes of the user P by referring to the user list 352 stored in the storage 350 (step S109). Subsequently, the advertisement determiner 320 determines an advertisement video (applied to a large signboard) to be included in the virtual reality video by referring to the advertisement list 354 stored in the storage 350 on the basis of the specified attributes of the user P (step S111). The advertisement determiner 320 notifies the video generator 330 of advertisement video information based on the determined advertisement video.

Subsequently, the video generator 330 generates a virtual reality video on the basis of the advertisement video reported by the advertisement determiner 320 and the local video reported by the communicator 310 (step S113). Here, the video generator 330 applies the advertisement video to the large signboard included in the local video to generate the virtual reality video.

The video generator 330 notifies the display controller 340 of information regarding the generated virtual reality video. Subsequently, the display controller 340 displays the virtual reality video reported by the video generator 330 on the display device 232 provided in the VR goggles 230 (step S115). Subsequently, the virtual experience device 300 determines whether or not the user P finishes the virtual experience travel, for example, by the user P getting off the second moving object 210 (step S117).

In a case where it is determined that the user P does not finish (continues) the virtual travel experience, the virtual experience device 300 returns the process to step S105 and causes the user P to continue the virtual travel experience. In a case where it is determined that the user P finishes the virtual travel experience, the virtual experience device 300 finishes the process shown in FIG. 8 without further processes.

The virtual experience device 300 of the first embodiment causes the user P to have a virtual travel experience while watching a virtual reality video in which an advertisement video determined on the basis of attributes of the user P who receives a service of the virtual experience device 300 is applied to a predetermined advertisement display region. Thus, the user P who has a virtual experience will have a virtual travel experience while watching the advertisement video included in the scenery. Therefore, since a discomfort given by the displayed advertisement is reduced, it is possible to increase the appeal to a user who has a virtual experience by watching a virtual reality video for an advertisement target.

### Second Embodiment

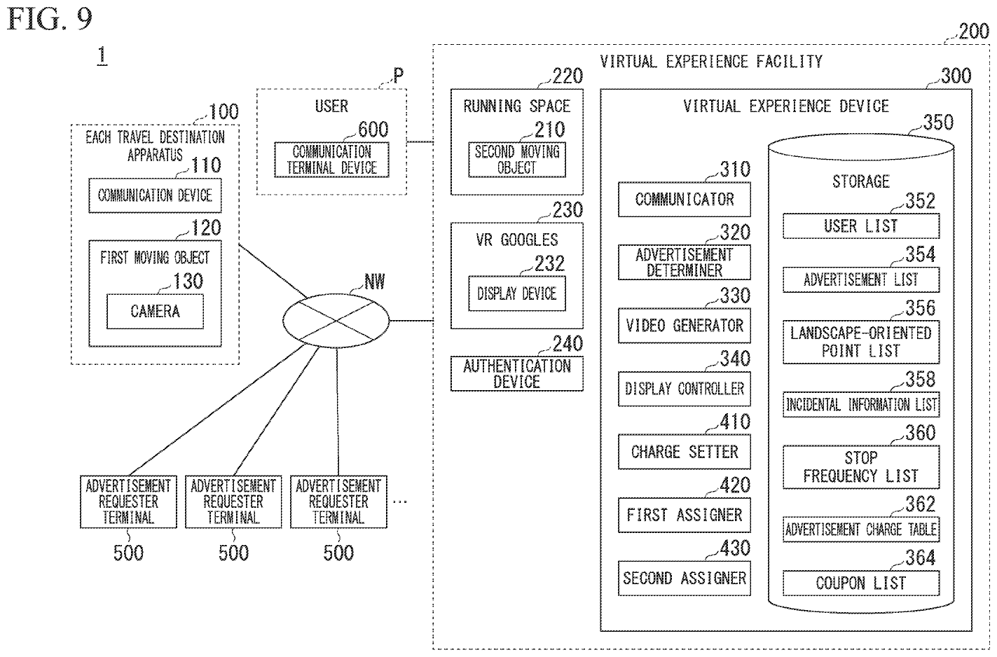

Next, a second embodiment will be described. FIG. 9 is a diagram showing an example of a configuration of a virtual experience device 300 of the second embodiment. The virtual experience device 300 of the second embodiment includes, for example, a communicator 310, an advertisement determiner 320, a video generator 330, a display controller 340, a charge setter 410, and a first assigner 420, and a second assigner 430. The charge setter 410, the first assigner 420, and the second assigner 430 are realized, for example, by a processor such as a CPU that is hardware executing a program together with the advertisement determiner 320, the video generator 330, and the display controller 340. The advertisement determiner 320, the video generator 330, the display controller 340, the charge setter 410, the first assigner 420, and the second assigner 430 may be realized by the LSI or the like described in the first embodiment.

The virtual experience device 300 of the second embodiment can further communicate with a communication terminal device 600 possessed by an experiencer via a network NW. The communication terminal device 600 is, for example, a portable terminal such as a smartphone or tablet PC possessed by the user P. In the communication terminal device 600, an application program for using the service provided by the virtual experience system 1, a browser, or the like is started to support a service provided by the virtual experience system 1.

The advertisement determiner 320 of the virtual experience device 300 specifies a place where the first moving object 120 moves on the basis of a local video output by the communicator 310 in addition to the process described in the first embodiment. The camera 130 of each travel destination apparatus 100 is provided with, for example, a global navigation satellite system (GNSS) device, and detects a position of the camera 130.

When transmitting the local video captured by the camera 130, the communication device 110 adds position information indicating the position detected by the GNSS device to the local video and transmits the local video to the virtual experience device 300. The communicator 310 specifies the place where the local video is captured on the basis of the position information transmitted together with the local video. Since the place where the local video is captured is where an advertisement video is displayed in a virtual reality video (hereinafter, an advertisement display place), the place where the local video is captured will be referred to as an advertisement display place in the following description. The advertisement display place may be determined in advance on the basis of a virtual travel experience plan or the like.

The advertisement determiner 320 uses the specified attributes of the user P and the advertisement display place specified on the basis of the position information and refers to the advertisement list 354 stored in the storage 350, and thus determines an advertisement video to be included in the virtual reality video on the basis of the attributes of the user P and the advertisement display place. The advertisement list 354 in the second embodiment is different from the advertisement list in the first embodiment. Hereinafter, the advertisement list 354 according to the second embodiment will be described.

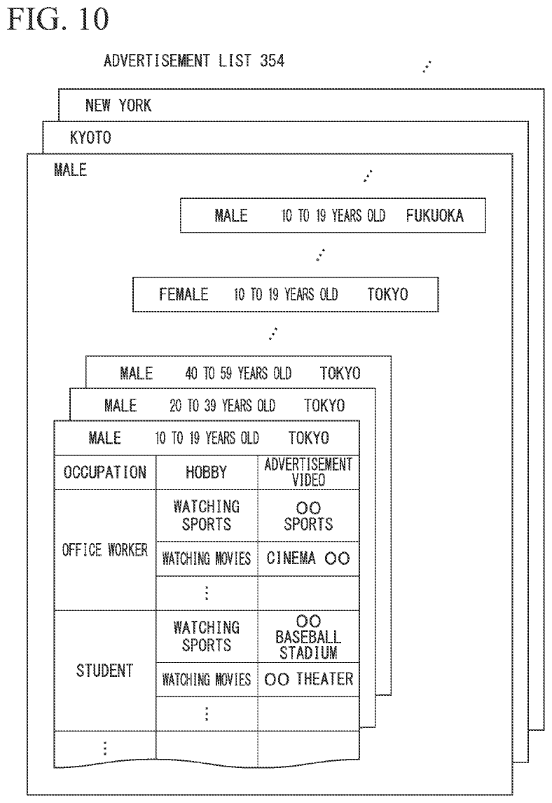

FIG. 10 is a diagram showing an example of details of the advertisement list 354 in the second embodiment. The advertisement list 354 is a list in which a plurality of lists divided by a gender, an age, and a residential area are collected for each advertisement display place. In the example shown in FIG. 10, for example, the list is created separately for advertisement display places such as “Tokyo”, “Kyoto”, and “New York”. For example, in a case where an advertisement display place is Kyoto, an advertisement video is determined by referring to the list of Kyoto. The advertisement display place is classified by an area, but may be classified by a division other than the area, for example, an individual visit place such as a park or a building.

In addition to the user list 352 and the advertisement list 354, the storage 350 stores a landscape-oriented point list 356, an incidental information list 358, a stop frequency list 360, an advertisement charge table 362, and a coupon list 364. Here, the landscape-oriented point list 356, the incidental information list 358, the stop frequency list 360, the advertisement charge table 362, and the coupon list 364 will be described.

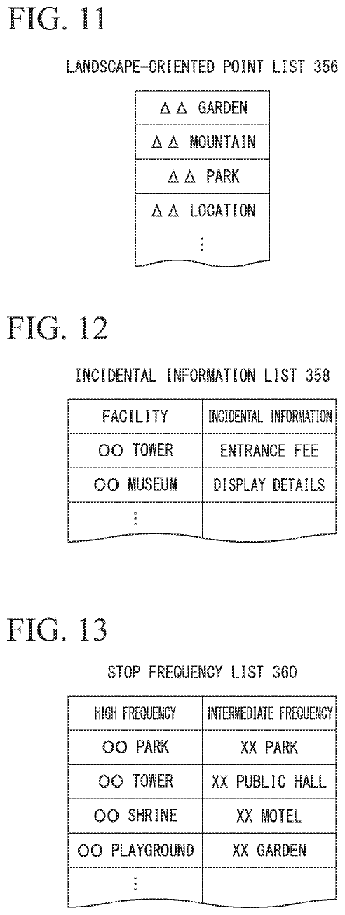

FIG. 11 is a diagram showing an example of details of the landscape-oriented point list 356. The landscape-oriented point list 356 includes, for example, points (places) designated in advance as having an excellent landscape. For example, gardens, mountains (natural objects), and parks are set in the landscape-oriented point list 356.

FIG. 12 is a diagram showing an example of details of the incidental information list 358. The incidental information list 358 includes, for example, a facility having incidental information and incidental information incidental to the facility. For example, in a case where the facility is OO Tower, the incidental information is an entrance fee for OO Tower. For example, in a case where the facility is OO Museum, the incidental information is exhibition details of OO Museum. The incidental information is, for example, information displayed on a large signboard included in a local video. A facility an example of an advertisement object. The advertisement object may be an object other than a facility, and may be, for example, a real estate such as a park, a natural object such as a river or a mountain, and a service such as cleaning.

FIG. 13 is a diagram showing an example of details of the stop frequency list 360. The stop frequency list 360 includes places where ordinary travelers and the like frequently stop (high frequency) and places where the frequency is intermediate (intermediate frequency). The stop frequency list 360 includes, for example, OO Park, and OO Tower as places with a high frequency, and XX Park, XX Public Hall, and the like as places with an intermediate frequency.

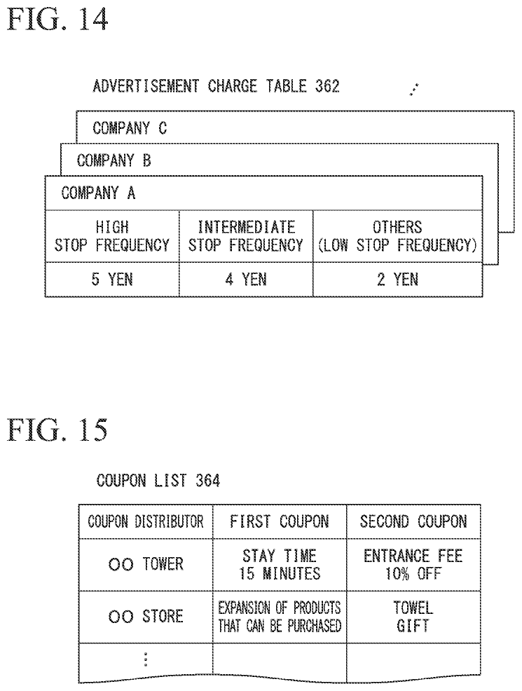

FIG. 14 is a table showing an example of the advertisement charge table 362. The advertisement charge table 362 is created for each advertisement requester. The advertisement charge table shows a billed amount requested by an administrator of the virtual experience device 300 to an advertisement requester when an advertisement video is displayed. The billed amount varies according to a stop frequency at a place where an advertisement video is displayed in the virtual reality video, and is set to become higher as the stop frequency becomes higher.

For example, in a case where an advertisement requester is Company A, a billed amount when an advertisement video is displayed in a place where the stop frequency is high in the virtual reality video (hereinafter, a high frequency stop place) is 5 yen. In a case where an advertisement video is displayed in a place where a stop frequency is intermediate in the virtual reality video (hereinafter referred to as an intermediate frequency stop place), a billed amount is, for example, 4 yen. In a case where an advertisement video is displayed in a place where a stop frequency is low in the virtual reality video (a place other than the high frequency stop place and the intermediate frequency stop place; hereinafter, a low frequency stop place), a billed amount is, for example, 2 yen. The advertisement charge table 362 is created for each advertisement requester.

FIG. 15 is a diagram showing an example of details of the coupon list 364. The coupon list 364 includes a coupon distributor that distributes a coupon, and information regarding a first coupon and a second coupon as coupons distributed by the coupon distributor. The first coupon is a coupon that can be used in the virtual reality video. The second coupon is a coupon that can be used in the real world.

In addition to the processes described in the first embodiment, the display controller 340 excludes the landscape-oriented point included in the virtual reality video from the place where the advertisement video is displayed in a case where the virtual reality video is a video representing the real world. For example, the display controller 340 uses position information added to the local video to specify a target object by referring to predetermined map information and determines whether or not the specified target object corresponds to a landscape-oriented point, the virtual reality video includes the landscape-oriented point. In a case where the virtual reality video includes the landscape-oriented point, the display controller 340 excludes the landscape-oriented point from the place where the advertisement video is displayed.

In a case where a facility having incidental information is included in the virtual reality video, the display controller 340 further displays the incidental information in preference to the advertisement video on the display device 232. For example, the display controller 340 uses position information added to the local video to specify a facility by referring to predetermined map information, and uses the specified facility to determine whether or not a facility having incidental information is included in the virtual reality video by referring to the incidental information list 358. The display controller 340 specifies incidental information by referring to, for example, the incidental information list 358, but may specify incidental information by reading characters displayed on a large signboard or the like included in the local video.

In a case where the virtual reality video includes a facility having incidental information, the display controller 340 displays the incidental information in preference to the advertisement video on the display device 232 instead of replacing the advertisement video with the incidental information included in the virtual reality video. In a case where the facility having the incidental information is included in the virtual reality video, the video generator 330 may generate the virtual reality video including the incidental information instead of the display controller 340 displaying the incidental information.

The charge setter 410 sets an advertisement charge requested to an advertisement requester when displaying an advertisement video in a case where the advertisement video is generated on the basis of advertisement request information transmitted by the advertisement requester terminal 500. The charge setter 410 adjusts the advertisement charge on the basis of the stop frequency in the virtual reality video and sets the advertisement charge to become higher as the stop frequency increases. The charge setter 410 creates an advertisement charge table 362 on the basis of the set advertisement charge and stores the advertisement charge table in the storage 350. The setting of the advertisement charge and the creation of the advertisement charge table 362 are executed, for example, before the user P has a virtual travel experience.

In a case where the local video is transmitted while the user P is experiencing a virtual travel, the charge setter 410 uses the position information added to the local video to specify an advertisement display place in the virtual reality video by referring to predetermined map information. The charge setter 410 uses the specified advertisement display place to specify a stop frequency at the advertisement display place by referring to the stop frequency list 360. The charge setter 410 calculates an advertisement charge on the basis of the specified stop frequency and generates advertisement charge information and transmits the advertisement charge information to the advertisement requester terminal 500 after the user P finishes the virtual travel experience.

The first assigner 420 assigns the first coupon to the user P in a case where the user P has executed a first action displayed in a coupon assignment advertisement video. The coupon assignment advertisement video is an advertisement video for notifying the user P that the first coupon or the second coupon is assigned to the user by executing the first action or a second action.

The first action is, for example, an action of stopping at OO Tower in the virtual reality video in a case where the advertisement video requests “Please stop at OO Tower”. For example, the first assigner 420 assigns the first coupon to the user P in the virtual travel experience while the user P is experiencing the virtual travel.

The second assigner 430 assigns the second coupon to the user P in a case where the user P executes the second action displayed on the advertisement video. The second action is, for example, an action of evaluating the OO store in the virtual reality video or after the virtual travel experience is finished in a case where the advertisement video requests “Please evaluate the OO store”.

The second assigner 430 assigns the second coupon to the user P by transmitting information regarding the second coupon to the communication terminal device 600, for example, while the user P is experiencing the virtual travel or after the virtual travel experience is finished. The first action and the second action do not have to be actions related to details (request) displayed in the advertisement video, and may be, for example, actions presented to the user in advance immediately before experiencing the virtual travel.

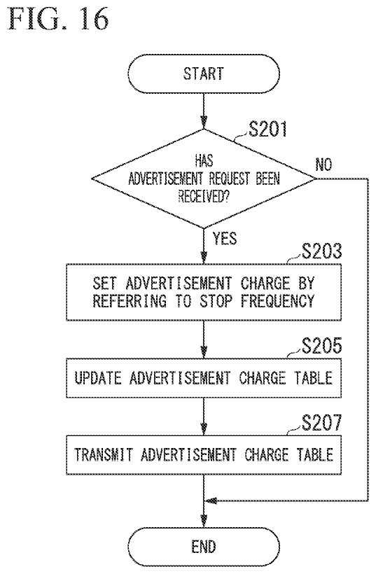

Next, a process of the virtual experience device 300 of the second embodiment will be described. First, as the process of the virtual experience device 300 of the second embodiment, a process before the user P has a virtual travel experience will be described. FIG. 16 is a flowchart showing an example of a process of the virtual experience device 300 of the second embodiment before the user P has a virtual travel experience.

First, the virtual experience device 300 determines whether or not the charge setter 410 has received advertisement request information transmitted by the advertisement requester terminal 500 (step S201). In a case where it is determined that the charge setter 410 has not received the advertisement request information, the virtual experience device 300 finishes the process shown in FIG. 16 without further processes. In a case where it is determined that the advertisement request information has been received, the charge setter 410 sets an advertisement charge by referring to the stop frequency list 360 shown in FIG. 13 (step S203). Subsequently, the charge setter 410 updates the advertisement charge table 362 stored in the storage 350 on the basis of the set advertisement charge (step S205).

Subsequently, the charge setter 410 transmits a portion corresponding to the set advertisement charge in the advertisement charge table 362 to the advertisement requester terminal 500 (step S207). As described above, the virtual experience device 300 finishes the process shown in FIG. 16.

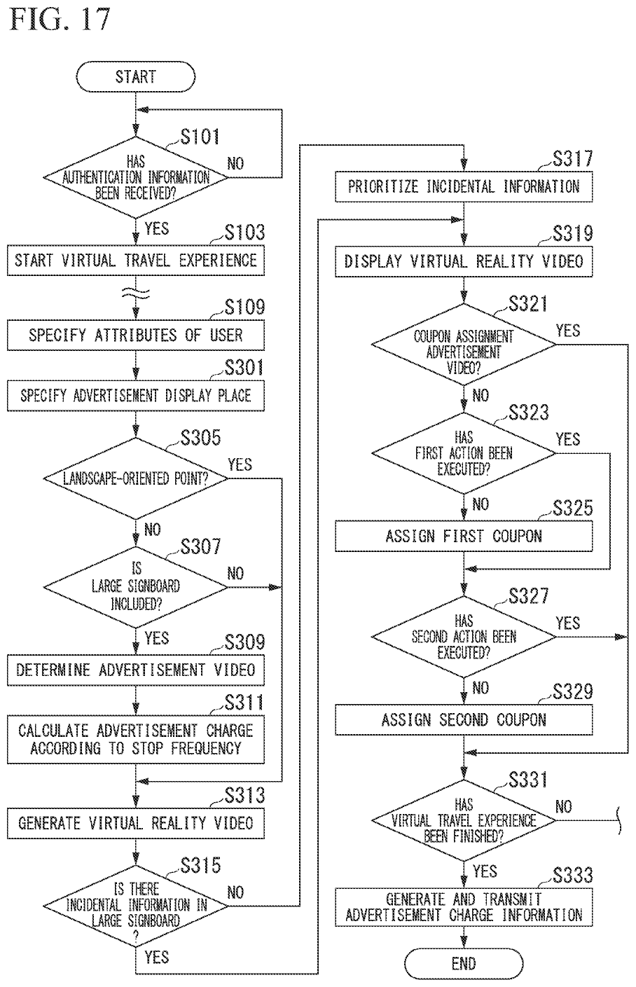

Next, a process of the virtual experience device 300 of the second embodiment in a case where the user P is experiencing a virtual travel will be described. FIG. 17 is a flowchart showing an example of a process of the virtual experience device 300 of the second embodiment in a case where the user P is experiencing a virtual travel. First, in the same manner as the virtual experience device 300 of the first embodiment, the virtual experience device 300 determines whether or not the advertisement determiner 320 has received authentication information transmitted by the authentication device 240 (step S101), repeatedly performs the process in step S101 until the authentication information is received, and causes the process to proceed to step S105. Thereafter, the same process as in the virtual experience device 300 of the first embodiment shown in FIG. 8 is executed until step S109.

After specifying attributes of the user P (step S109), the virtual experience device 300 specifies an advertisement display place in the advertisement determiner 320 (step S301). Subsequently, the advertisement determiner 320 determines whether or not the advertisement display place is a landscape-oriented point by referring to the landscape-oriented point list 356 (step S303). In a case where it is determined that the advertisement display place is a landscape-oriented point, the advertisement determiner 320 determines that an advertisement video is not displayed at the advertisement display place, and causes the process to proceed to step S313.

In a case where it is determined that the advertisement display place is not a landscape-oriented point, the advertisement determiner 320 determines whether or not the local video includes a large signboard (step S307). In a case where it is determined that the local video does not include a large signboard, the advertisement determiner 320 determines that an advertisement video is displayed and causes the process to proceed to step S313.

In a case where it is determined that the local video includes a large signboard, the advertisement determiner 320 determines an advertisement video to be displayed in the advertisement display region by referring to the advertisement list 354 on the basis of the attributes of the user P and the advertisement display place (step S309). Subsequently, the charge setter 410 specifies a stop frequency at the advertisement display place in which the advertisement video is displayed and uses the specified stop frequency to calculate an advertisement charge by referring to the advertisement charge table 362 (step S311).

Subsequently, the video generator 330 generates a virtual reality video on the basis of the advertisement video reported by the advertisement determiner 320 and the local video reported by the communicator 310 (step S313). Here, the video generator 330 applies the advertisement video to the large signboard included in the local video to generate the virtual reality video.

Subsequently, the display controller 340 determines whether or not the large signboard included in the local video includes incidental information possessed by the facility (step S315). In a case where it is determined that the large signboard includes the incidental information, the display controller 340 gives priority to the incidental information over the advertisement video (step S317). In this case, the display controller 340 displays the virtual reality video on the display device 232 such that the incidental information is displayed without displaying the advertisement video in the advertisement display region (step S319). In a case where it is determined that the large signboard does not include the incidental information, the display controller 340 skips step S317 and displays, on the display device 232, the virtual reality video in which the advertisement video is displayed in the advertisement display region (step S319).

Subsequently, the first assigner 420 and the second assigner 430 determine whether or not the advertisement video is a coupon assignment advertisement video (step S321). In a case where it is determined that the advertisement video is not a coupon assignment advertisement video, the virtual experience device 300 causes the process to proceed to step S325. In a case where it is determined that the advertisement video is a coupon assignment advertisement video, the first assigner 420 determines whether or not the user P has executed the first action (step S323).

In a case where it is determined that the user P has executed the first action, the first assigner 420 assigns the first coupon to the user P (step S325). In a case where it is determined that the user P has not executed the first action, the first assigner 420 causes the process to proceed to step S117 without further process. Subsequently, the second assigner 430 determines whether or not the user P has executed the second action (step S327).

In a case where it is determined that the user P has executed the second action, the second assigner 430 assigns the second coupon to the user P (step S329). In a case where it is determined that the user P has not executed the second action, the second assigner 430 causes the process to proceed to step S117 without further process. Subsequently, the virtual experience device 300 determines whether or not the user P has finished the virtual travel experience (step S331). In a case where it is determined that the user P has not finished the virtual travel experience, the virtual experience device 300 returns the process to step S105 and causes the user P to continue the virtual travel experience in the same manner as in the first embodiment shown in FIG. 8.

In a case where it is determined that the user P has finished the virtual travel experience, the charge setter 410 generates advertisement charge information on the basis of the advertisement displayed on the display device 232 in the virtual travel experience and transmits the advertisement charge information to the advertisement requester terminal 500 (step S333). As described above, the virtual experience device 300 finishes the process shown in FIG. 17.

The virtual experience device 300 of the second embodiment achieves the same advantageous effects as those of the virtual experience device 300 of the first embodiment. The virtual experience device 300 of the second embodiment further sets an advertisement charge according to a stop frequency when requesting the advertisement charge to an advertisement requester. Thus, it is possible to easily set an advertisement charge commensurate with an advertisement effect.

The virtual experience device 300 of the second embodiment excludes a landscape-oriented point from a region area where an advertisement video is displayed. Thus, since an advertisement video in a region where a ratio of enjoying the landscape is high is omitted, the user P can fully enjoy the landscape, and thus it is possible to reduce the feeling of the user P that the advertisement video is bothersome.

The virtual experience device 300 of the second embodiment displays incidental information in preference to an advertisement video on the display device 232 in a case where the incidental information possessed by a facility is included in a virtual reality video. Thus, it is possible to easily convey important information to the user when experiencing a virtual travel.

In each of the above embodiments, an advertisement video is displayed regardless of conditions when the user P uses the virtual experience facility 200, but display of the advertisement video may be omitted in a virtual experience by satisfying predetermined conditions. For example, display of the advertisement video may be omitted by increasing a usage fee of using the virtual experience facility 200. Alternatively, for example, in a case where the virtual experience device 300 provides a virtual experience of a game, and the user P can receive recorded data for a fee or free of charge, display of the advertisement video may be omitted by the user P receiving the recorded data for a fee.

In each of the above embodiments, the case where a virtual travel experience is provided in the virtual experience facility 200 has been described. However, for example, in a case where the virtual experience facility 200 provides a so-called role-playing game, a virtual reality video may be created. In the virtual reality video, an advertisement display region may be freely set, and for example, a signboard video may be created at any position.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description and is only limited by the scope of the appended claims.

What is claimed is:

1. A virtual experience device comprising:
a storage medium that stores computer-readable instructions; and
a processor connected to the storage medium,
wherein the processor executes the computer-readable instructions to
provide a user with a service that allows the user to have a virtual experience in a virtual reality video based on a virtual world that virtually reproduces a real world or a fictional world,
determine an advertisement video to be included in the virtual reality video on the basis of attributes of the user who receives the service,
generate the virtual reality video including the advertisement video in a predetermined advertisement display region, and
display the virtual reality video on a display device.

2. The virtual experience device according to claim 1,
wherein the processor
sets an advertisement charge for displaying the advertisement video,
adjusts the advertisement charge on the basis of the user's stop frequency in the virtual reality video, and
sets the advertisement charge to become higher as the stop frequency becomes higher.

3. The virtual experience device according to claim 2,
wherein the virtual reality video is a video that virtually reproduces the real world, and
wherein the processor excludes a region of the virtual reality video that overlaps a landscape-oriented point in the real world from a region where the advertisement video is displayed.

4. The virtual experience device according to claim 1,
wherein the processor determines the advertisement video further on the basis of an advertisement display place which is a place where the advertisement video is displayed.

5. The virtual experience device according to claim 4,
wherein, in a case where incidental information possessed by a target object is included in the virtual reality video, the processor displays the incidental information in preference to the advertisement video on the display device.

6. The virtual experience device according to claim 1,
wherein the advertisement video is an advertisement video for assigning a first coupon that can be used in the virtual world to the user, and
wherein the processor assigns the first coupon to the user in a case where the user executes a first action while the user is receiving the service or after the user has received the service.

7. The virtual experience device according to claim 1,
wherein the advertisement video is an advertisement video that assigns a second coupon that can be used in the real world to the user, and
wherein the processor assigns the second coupon to the user in a case where the user executes a second action while the user is receiving the service or after the user has received the service.

8. A virtual experience method of causing a computer to:
provide a user with a service that allows the user to have a virtual experience in a virtual reality video based on a virtual world that virtually reproduces a real world or a fictional world;
determine an advertisement video to be included in the virtual reality video on the basis of attributes of the user who receives the service;
generate the virtual reality video including the advertisement video in a predetermined advertisement display region; and
display the virtual reality video on a display device.

9. A non-transitory storage medium storing computer-readable instructions for causing a computer to execute:
providing a user with a service that allows the user to have a virtual experience in a virtual reality video based on a virtual world that virtually reproduces a real world or a fictional world;
determining an advertisement video to be included in the virtual reality video on the basis of attributes of the user who receives the service;
generating the virtual reality video including the advertisement video in a predetermined advertisement display region; and
displaying the virtual reality video on a display device.
